(19) United States
(12) Patent Application Publication
(10) Pub. No.: US 2012/0063624 A1
(43) Pub. Date: Mar. 15, 2012

(54) AUDIO BASE OF A TABLET PERSONAL COMPUTER

(76) Inventor: Shao-Chieh TING, Banchiau City (TW)

(21) Appl. No.: 12/880,840

(22) Filed: Sep. 13, 2010

(51) Int. Cl. H04R 1/02

(52) U.S. Cl. 381/333

(57) ABSTRACT

The present invention discloses an audio base of a tablet personal computer. A front rim of an audio base body is provided with a tablet personal computer upright emplacing slot and a rear rim is provided with a semi-circular slot to emplace a barrel-shaped speaker. A circumference of the barrel-shaped speaker is provided with at least one circular soft rubber collar, a surface of which is rough or has a granular texture; whereas, the tablet personal computer is sheathed with a protection cover of soft silicon.

### BACKGROUND OF THE INVENTION

a) Field of the Invention

The present invention relates to an audio base of a tablet personal computer, and more particularly to an audio base which allows a tablet personal computer to be put upright horizontally or vertically on the audio base to facilitate reading by a user. In addition, by this audio base, a tablet personal computer which is sheathed with a protection cover of soft silicon can be laid horizontally or vertically on a working platform or a barrel-shaped audio to facilitate touching a screen by the user.
b) Description of the Prior Art

As development of technologies, one must pursue a small size and a light weight for the tablet personal computer that the user can carry conveniently. However, when the tablet personal computer is getting smaller, user convenience in operation will be limited in someway.

Accordingly, a lot of bases of the tablet personal computers arise in markets to facilitate operation and utilization by the user. Nevertheless, all the bases of the tablet personal computers sold on existing markets are not equipped with audio devices and as an audio effect built into the tablet personal computer is limited that it is unable to satisfy the user's request to a maximum extent, which is indeed a pity.

Accordingly, an audio base of a tablet personal computer is provided by the present inventor to solve the aforementioned problem, thereby improving the audio effect of the tablet personal computer.

### SUMMARY OF THE INVENTION

The primary object of the present invention is to provide an audio base of a tablet personal computer, wherein the audio device allows a tablet personal computer to be stacked. The audio base includes primarily a base body, an audio, a bottom cover and plural foot pieces.

Another object of the present invention is to provide an audio base of a tablet personal computer, wherein through slots on the base body, the tablet personal computer can be put upright horizontally or vertically on the audio base to facilitate reading and watching videos by the user.

Still another object of the present invention is to provide an audio base of a tablet personal computer, wherein through circular soft rubber collars, surfaces of which are rough or have a granular texture, on the audio, vibration of speakers produced in bass tone can be avoided.

Yet still another object of the present invention is to provide an audio base of a tablet personal computer, wherein through the circular soft rubber collars, the surfaces of which are rough or have the granular texture, on the audio, fitting with a tablet personal computer which is sheathed with a protection cover of soft silicon, the tablet personal computer can be reclined horizontally or vertically on the working platform and a barrel-shaped audio. Moreover, an angle of reclination of the tablet personal computer can be adjusted, which is even more convenient in operating a keyboard and touching the screen by the user.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of an audio base of a tablet personal computer, according to the present invention.

FIG. 2 shows a three-dimensional exploded view of the audio base of a tablet personal computer, according to the present invention.

FIG. 3 shows a three-dimensional schematic view of a tablet personal computer which is put upright horizontally on the audio base, according to the present invention.

FIG. 4 shows a three-dimensional schematic view of a tablet personal computer which is put upright vertically on the audio base, according to the present invention.

FIG. 5 shows a three-dimensional schematic view of a tablet personal computer which is laid horizontally on an audio and a working platform, according to the present invention.

FIG. 6 shows a three-dimensional schematic view of a tablet personal computer which is laid vertically on the audio and the working platform, according to the present invention.

FIG. 7 shows a side view of a tablet personal computer which is laid horizontally (or vertically) on the audio and the working platform, according to the present invention.

### DETAILED DESCRIPTION OF THE PREFERRED EMBODIMENTS

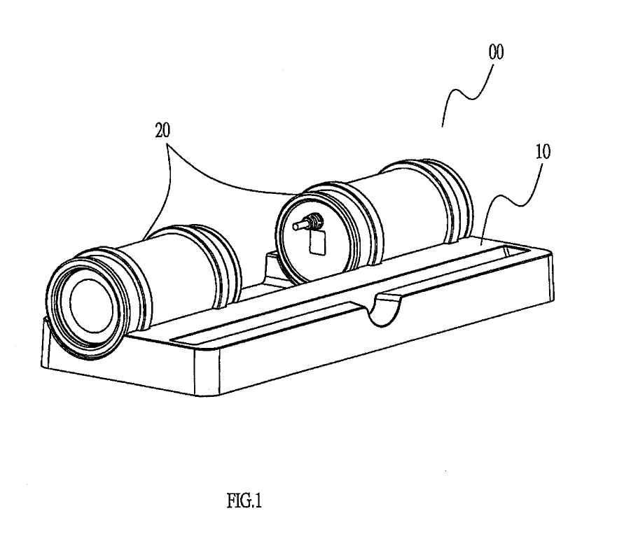

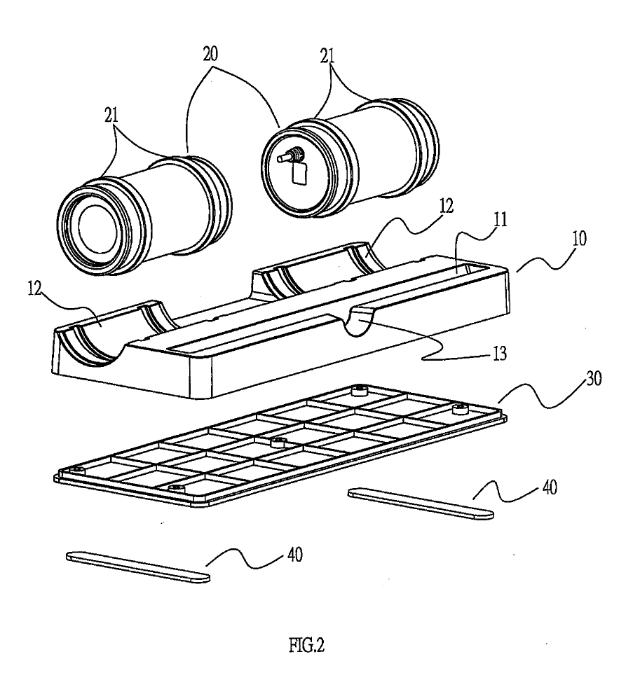

It is first to declare that a tablet personal computer as described in the present invention includes a tablet TV and other tablet products. Referring to FIG. 1 and FIG. 2, it shows a three-dimensional schematic view and a three-dimensional exploded view of an audio base of a tablet personal computer, according to the present invention. As shown in the drawings, the audio base 00 of the present invention comprises a base body 10, a barrel-shaped audio 20, a bottom cover 30 and plural foot pieces 40.

The base body 10 is used for stacking a tablet personal computer and an audio device. A front part of the base body 10 is provided with a tablet personal computer upright emplacing slot 11 and a finger slot 13; whereas, a rear part is provided with audio emplacing slots 12.

A barrel-shaped audio 20 is provided, a circumference of which is provided with at least one vibration-proofed circular soft rubber collar 21 which takes a rough surface or a surface of a granular texture (not shown in the drawings) to prevent from vibration of speakers produced in bass tone and to allow for emplacing the tablet personal computer when it is put reclined.

The bottom cover 30 is covered on a bottom of the base body 10.

The foot pieces 40 are used to prevent the audio base 00 from sliding on a working platform.

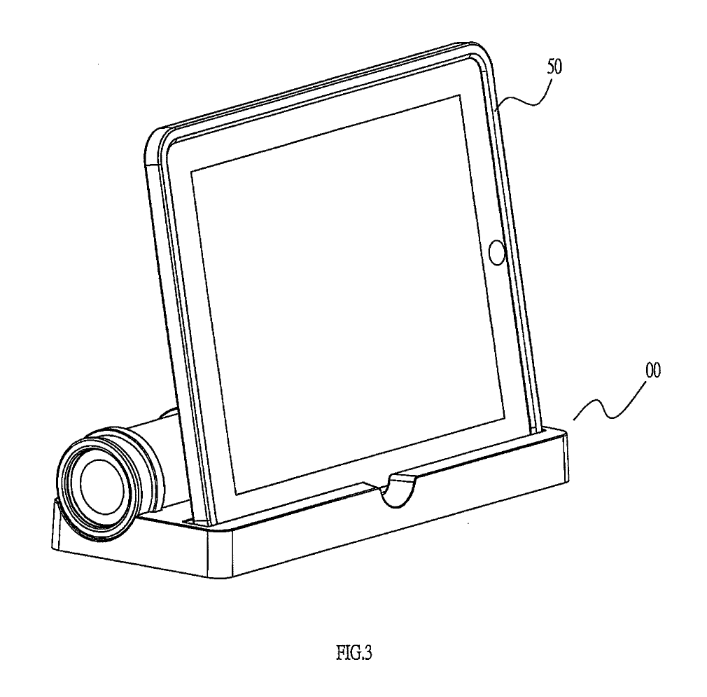

Referring to FIG. 3, it shows a three-dimensional schematic view wherein a tablet personal computer 50, which is sheathed with a protection cover of soft silicon, is put upright horizontally on the audio base 00.

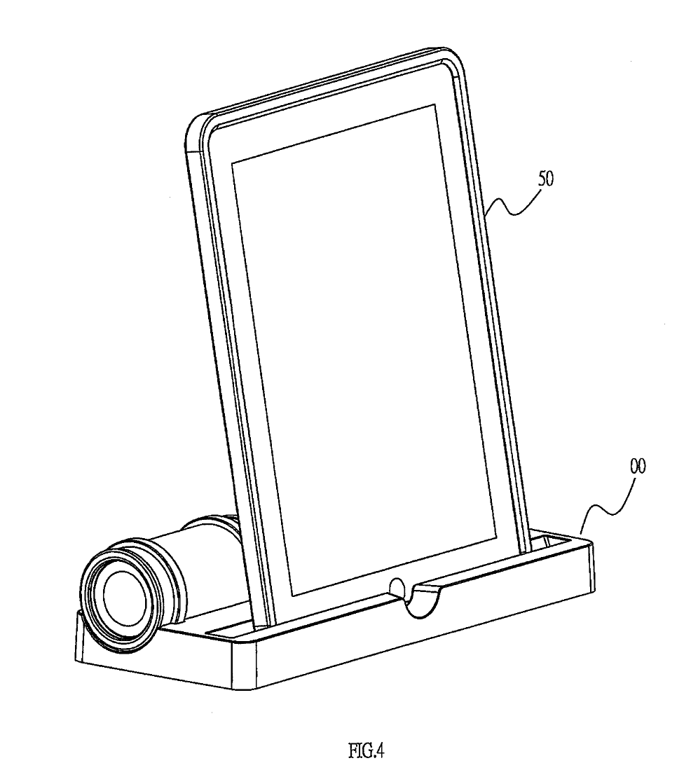

Referring to FIG. 4, it shows a three-dimensional schematic view wherein the tablet personal computer 50 that is sheathed with the protection cover of soft silicon is put upright vertically on the audio base 00.

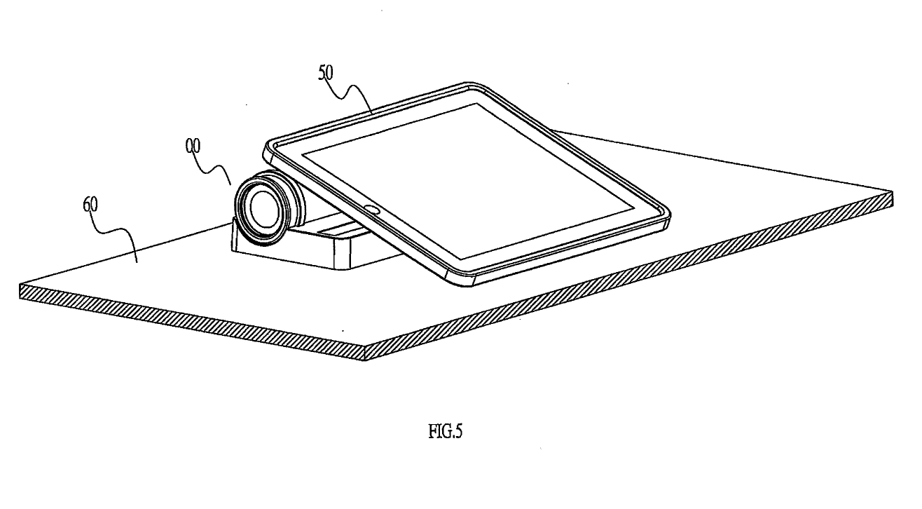

Referring to FIG. 5, it shows a three-dimensional schematic view wherein the tablet personal computer 50 that is sheathed with the protection cover of soft silicon is laid horizontally on the audio base 00 and a working platform 60.

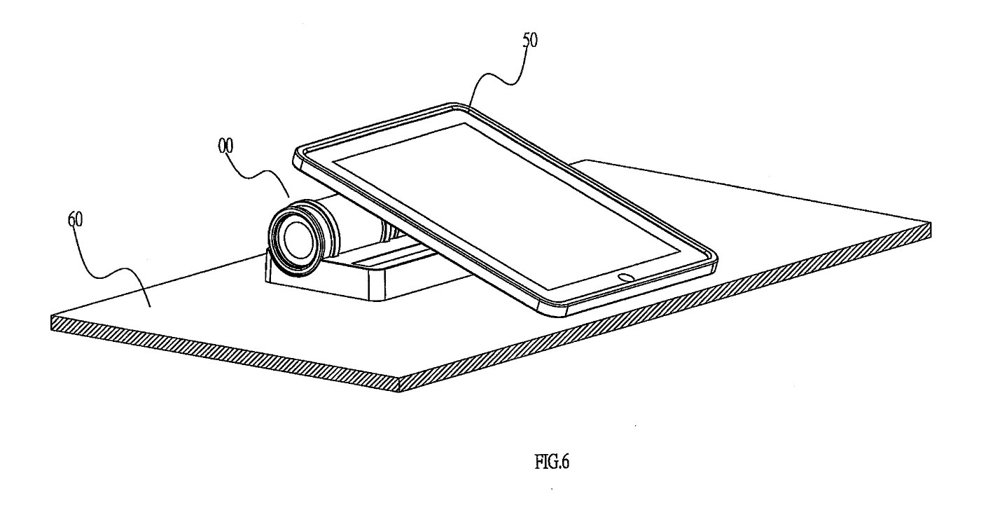

Referring to FIG. 6, it shows a three-dimensional schematic view wherein the tablet personal computer 50 that is sheathed with the protection cover of soft silicon (not shown in the drawing) is laid vertically on the audio base 00 and the working platform 60.

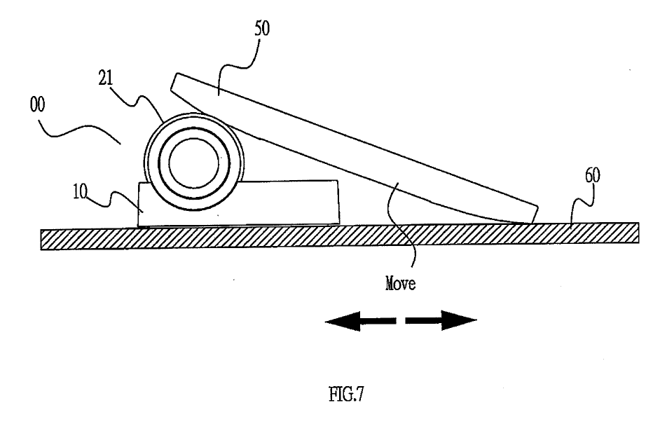

Referring to FIG. 7, it shows a side view wherein the tablet personal computer 50 that is sheathed with the protection cover of soft silicon is laid horizontally (or vertically) on the audio base 00 and the working platform 60, with that a proper angle of the tablet personal computer 50 that is sheathed with the protection cover of soft silicon can be adjusted on the working platform 60, according to the user's need.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An audio base of a tablet personal computer, comprising:
a base body which is used to emplace a tablet personal computer and a barrel-shaped audio;
wherein the barrel-shaped audio, a circumference of which is provided with at least one circular vibration-proofed soft rubber collar with that a surface of the collar, thereby laying the tablet personal computer;
a bottom cover which is used to cover a bottom of the base body; and
plural foot pieces which are provided on the bottom cover thereby preventing the audio base from sliding on a working platform.

2. The audio base of a tablet personal computer, according to claim 1, wherein the tablet personal computer includes a tablet TV or other tablet products.

3. The audio base of a tablet personal computer, according to claim 1, wherein the barrel-shaped audio device is provided with the circular soft rubber collars, surfaces of which are rough or have a granular texture.

4. The audio base of a tablet personal computer, according to claim 1, wherein the tablet personal computer is sheathed with a protection cover of soft silicon.

5. The audio base of a tablet personal computer, according to claim 2, wherein the tablet personal computer is sheathed with a protection cover of soft silicon.
